(19) United States
(12) Patent Application Publication
(10) Pub. No.: US 2011/0226589 A1
(43) Pub. Date: Sep. 22, 2011

(54) Mechanic extractor of dry grains stored in silage bag with discharge accelerator

(75) Inventor: Alberto José Bartolomé Gaviglio, San Francisco, Cordoba (AR)

(73) Assignee: Micron Fresar S.R.L.

(21) Appl. No.: 12/926,265

(22) Filed: Nov. 5, 2010

(30) Foreign Application Priority Data
Mar. 22, 2010 (AR) AR 20100100916
May 19, 2010 (AR) AR 20100101744

(51) Int. Cl. B65G 65/22

(52) U.S. Cl. 198/518

(57) ABSTRACT

An extracting machine has a transverse roll that rolls a silage bag up as grains stored therein are extracted, to be discharged to a hopper truck. An extracting head placed in the interior of the bag has a lifting auger centrally arranged at the bottom thereof, and transverse augers extending to both sides move the grains to the lifting auger, which elevates and discharges them. A central transmission box supported at the bottom of the bag has plural output shafts extending in different directions, lying in a single vertical plane, and coupling to, respectively, the transverse augers and the lifting auger. A pusher shovel extending transversely the width of the bag has a hydraulically-adjustable transverse plate.

### FIELD OF THE INVENTION

The present invention mainly refers to a mechanic extractor of dry grains stored in silage bag with discharge accelerator, distinguished as it proposes a new transmission of control, with mechanic functioning, which results, as a functional consequence, a better use of the transmitted power, as well as a better disposal of lateral sweeping augers which feed the lifting and extractor auger of the stored grain, and consequently perform a much more efficient work.

Concretely, the present patent of invention refers to a new extracting machine of dry grains, which belongs to the type of those which work in association to the strength inlet of a tractor, for mechanic transmission, as well as they recur to an hydraulic engine, through which a transversal roll is operated which rolls the bag up as the stored grains therein are extracted and discharged onto a hopper truck or the like, which advances adjacent to the extracting machine.

These machines, for the extraction of stored grains, use an extracting head which is placed in the interior of the bag, which comprises a lifting auger centrally arranged which corresponds to the bottom thereof, combined with a pair of transversal augers extending to both sides on an horizontal plate, acting as auger resources that, during the advancement, orientate grains to the central line so they can be taken by said lifting auger which elevates and discharges them.

The novelty distinguishing the extracting machine of the present invention is related with the incorporation of a new transmission of control with mechanic functioning coming from coupling with the strength inlet of the tractor, where the combination of used organs, its assembly and arrangement, has the main advantage to place said augers transversally onto the ground, combined with an aligned arrangement, in the same vertical plan, with the above mentioned lifting auger they converge to, thus optimizing, this way, the sweeping task they perform during their work coordinated with the lifting and discharge action.

Therefore, the installation of control transmission shown by the invented extractor, refers to the use of a transmission box centrally mounted and adjacent to the bottom of the bag, which exit axis to the respective augers are projected to different directions, keeping the same vertical plan.

As exposed above, a very simple and direct assembly is described which is specially distinguished for the fact it facilitates installation, assembly and maintenance.

More precisely, the present extractor of dry grains also refers to a novel and special pusher shovel, created to be disposed as external and inferior backup of the silage bag which is being rolled up as the machine extracts grains stored therein.

It refers to a flat plate which is transversally placed covering the width of the silage bag, which function is to constitute an external parameter of contention and pushing to prevent that part of the mass of grains contained in the bag which is being rolled up is left outside the scope of action of the internal sweeping endless rollers possessed by the mechanic extracting machine.

This way the sweeping action of said transversal endless rollers is very well used, since they receive a bigger amount of feeding, thus accelerating the action of extraction of grains and also assuring that said extraction is almost total, without remaining materials demanding additional, boring and slow manual work.

The pusher shovel which is part of the invented extractor of dry grains includes a transversal plate mounted on a sliding frame associated to the plumber of a hydraulic cylinder which is operated from the operation cabinet of the machine.

As disclosed above, the operator of the machine will be able to push the bag avoiding it to be to stretched, and at the same time approach the bottom of the bag to the action zone of the above mentioned transversal sweeping endless rollers.

This refers to an invention defining a new combination of means intended to achieve a higher result, being same unpredictable and surprising even for a person skilled in the art. Accordingly, besides it is new, its constructive and functional conception shows a clear inventive activity, such that it gathers the conditions demanded by law to be considered a patent of invention.

### BACKGROUND ART

Known extracting machines, which respond to the above mentioned functioning principle, show a system of augers comprising a vertical and central lifting auger keeping its lower end on a sliding skate, in direct communication with the bottom of the bag, associated with a pair of endless rollers mounted laterally on a single transversal axis, which extend adjacent to the above referenced bottom, also resting on annular skates.

In some cases, the movement of this system of endless rollers is supplied from a transmission box, therefore the transversal endless rollers are disposed mounted on a single command axis, showing their respective helix conveying flaps with such orientation to execute the movement to the longitudinal central line of the storage bag.

Said transmission box also shows a second exit axis which constitutes the lifting roller command, which is fed from the grains centrally discharged by said transversal rollers.

Even though it is an extracting system with good operating results, some are appreciated which are shown when the flow rate or grain flow exiting the discharge mouth of the lifting roller is discontinuous, with good caudal mouths, alternated with others with a low caudal.

Also appreciated are the discontinuations when the body of the bag being rolled up shows any irregularity, or either alterations of the field where it advances, in which case the lateral endless rollers do not perform a suitable sweeping.

In all these cases, the coordinated work to be performed by the above mentioned lateral rollers and the vertical lift, sometimes is shown defective as some percentage of the sweeping performed by them is not taken by the central lift. In some cases, the bottom of the bag which advances and is elevated to its rolling up, deviates the mass of grains to zones or sectors where they cannot be effectively taken by the lower end of the central elevator.

Also mentioned as background art is the extracting machine described in Argentinean Patent Application P 090100056 titled “Extractor of Dry Grains Stored in Silage Bags”, belonging to the same holder of the present application.

In this background the lateral endless rollers take the grain mass at the bottom of the bag to convey them to a lower feeding chamber defining a centrally placed box, where the end of the charge of vertical lift is placed.

This new functioning principle is based on the fact that, the front of attack of the above mentioned lateral rollers is very wide, so that they will always be in contact with a big mass or volume of stored grains. If they are integrally conveyed to the lower and central chamber, the mass of grains shown to be lifted is always kept at a great caudal.

Said lower feeding chamber, is a closed chamber which communicates with the above mentioned horizontal lateral endless rollers, as well as with the vertical lift which is projected from a higher tubular communication of the same chamber.

In order to take the above explained functioning principle into practice, the lateral endless rollers are mounted on independent axes, and associated with respective individual commands.

This way, both lateral rollers may be aligned or offset with respect to the vertical axis of the lift, as well as aligned or offset among them.

This background is characterized in that it shows a command transmission system which is quite complex since it should produce the transmission of movement to each one of these lower transversal rollers independently for each one.

For that, use a command box which is disposed elevated as regards the bottom of the bag, from where an axis exits which extends downwards for transmitting the movement to the central lifting roller. Therefore, this lift should be in offset to the vertical plan, as regards the transversal rollers.

In this background, the above mentioned elevated command box has a lateral exit from where movement is transmitted to the intermediate transversal axis (15), by using a small system of gears, chains and pulleys.

Precisely, said intermediate axis acts as rotating axis which brings movement to each independent command which operates a respective sweeping roll; thus being the transmission through the corresponding chain extending between pulleys useful to both axis.

From the above, it is clear that this is a transmission system which is complex to be installed and costly to maintain.

In this sense, it is emphasized that the above mentioned problem appears with the assembly condition of placing the vertical lift in offset respect the transversal rollers.

On the other hand, many times the bottom of the bag which advances and is elevated until it is rolled up, deviates the mass of grains to zones or sectors where they cannot be efficiently taken by the lower end of the central elevator.

It is therefore noted that, even though the front of attack of the above mentioned transversal sweepers is very wide, many times its work capability is not efficiently used.

Doubtlessly, the higher is the caudal of the grain received by them, the higher will be the speed of total discharge executed by the machine since the volume of grains delivered to the vertical elevator is bigger.

It has been also shown that at the end of the mechanic discharge performed by these well known extracting machines, remaining grains are left which are not swept by the above mentioned transversal endless rollers since the deformed bottom of the silage bag accumulates them in sectors which are not taken by said endless rollers.

In these cases, the only way is to proceed with the manual extraction by the use of shovels and buckets with workers who can access to these sectors, all of which shows a clear signal of inefficiency of the extracting machine.

### DESCRIPTION OF THE INVENTION

The grain extracting machine disclosed in present invention is distinguished among all the machines of this kind, for the novel and special combination of means constituting the command transmission from the pulling tractor.

This refers to a mechanic transmission distinguished by the simplicity of assembly, which clearly simplifies the installation, repair and maintenance.

Therefore, the invention transmission recurs to the use of a gear box which is disposed adjacent at the bottom of the silage bag, with the particularity that the exit axis for the transversal endless rollers and the axis of the lifting roller, are disposed substantially co-planar to the vertical plan, which gives the security that the grain mass that is swept by the lateral endless rollers will be effectively taken by the vertical lifting roller centrally arranged.

On the other hand, taking into account said lower disposition of the above mentioned transmission box, it has been achieved that the endless transversal rollers work practically adjacent to the bottom of the bag, thus assuring that the sweep is total without damage to the grains and the body of the bag.

Therefore, the invented machine shows an entry axis specially conceived to take the movement coming from the tractor, disposed on the way at a substantially vertical beam which maintains the same slope as the body of the vertical lifting roller.

Through said frontal beam runs an uplift chain which brings the movement to a main transmission axis included in an enlarged structural frame which integrates the chassis of the machine, which extends to a lateral side of the body of the above mentioned vertical lift or chassis where it is associated to the second lowering chain extending to the transmission box which is centrally placed, at the lower extreme, adjacent to the bottom of the bag, in correspondence with the front face of the machine.

Said transmission box, resting on sliding skates, is distinguished because it has both lateral coupling exits with the above mentioned endless transversal rollers, duly aligned and at the same vertical plan than the exit axis which is coupled with the vertical lift, which, at its turn, keeps the same degree of slope.

It is clear that this way it has been notably simplified the transmission of command movement to the endless rollers, specially, as regards the individual chain systems required for the movement of the rollers and the central elevator which discloses said patent application P 090100056.

It can be said that with the shovel of this invention the integral work of the machine is accelerated, since with the same work there is an increase of the caudal of grains conveyed to the discharge.

Likewise, given the inferior and transversal placement of the shovel, any deviation in the rolling up of the bag does not affect the work of grains discharge since the shovel acts as a pusher frame which generates the displacement of them to the transversal endless rollers.

Due to the external and inferior position, the invented shovel is contacted with the body of the bag preventing the formation of sectors receptors of grains, which are apart from the scope of action of said sweeping endless rollers.

In order to take the above mentioned advantages of use and functioning, the shovel of this invention includes a structure, preferably tubular, rigid and light, rectangular shaped with a dimension equivalent to the transversal space occupied by the sweeping endless rollers.

On said structure, there appears a substantially rectangular flat plate, which may be of steel or plastic material, which defines the active front of the shovel, foreseen to be exteriorly supported on the silage bag in its inferior part, without any damage. Its specific function is to assure that the bottom of the bag is always where the above mentioned transversal sweeping endless rollers work.

Said pusher transversal plate, is mounted on a sliding and central frame which is projected from a support fixed to the chassis of the machine in a lower sector below the rolling rod of the bag.

Finally it is noted that said sliding frame is associated to the plumber of a hydraulic cylinder which is operated by the worker to increase or reduce the pushing pressure which is carried out with the invented shovel and therefore the worker regulates the positioning according to the operating needs that show up.

### INVENTIVE ACTIVITY

No currently known machine extracting grains from storage bags propose, or even suggest the constructive solution which arises from the above paragraphs, reason for which this is a proposal that, besides of being novel, has a clear inventive activity.

### BRIEF DESCRIPTION OF THE DRAWINGS

In order to achieve the above mentioned advantages, to which users and those skilled in the art may add many others, and in order to facilitate the understanding of the constructive, constitutive and functional features of the invented machine, a preferred embodiment example is described below which is shown, schematically and without a determined scale, on the enclosed drawings, with the express nota that, precisely, for being an example, they should not be used as limitative or exclusive of the scope of the invention, but it is simply explanatory and illustrative of the basic conception thereof.

FIG. 1 is a perspective view that shows the extracting machine of this invention, in its general assembly aspect, shown from the back linked to the tractor.

FIG. 2 is an enlarged detail, in perspective, that shows the download of the command transmission to the gear box which is placed at the lower and central sector of the same extracting machine.

FIG. 3 is a front view of the same machine of the above figures, where the lower extracting head is distinguished.

FIG. 4 is a perspective view of the transmission box chosen for the installation set forth by the extracting machine of this invention.

FIG. 5 is a widened detail of the lower and front sector of the same machine as the above figures.

FIG. 6 is a perspective view that shows the same extracting machine as previous figures, in this case incorporating a lower pusher shovel to be arranged exteriorly, supported on the silage bag which is being rolled up.

FIG. 7 is another perspective view, similar to previous figure, included to appreciate from another side the same inferior pusher shovel.

FIG. 8 is a lateral view of the same extracting machine of previous figures.

FIG. 9 is a widened detail, in perspective, showing the assembly of the pusher shovel associated to the sliding frame supporting same.

FIG. 10 is a widened detail of the pusher shovel observed from its main active side.

FIG. 11 is a lateral widened detail of the same pusher shovel of the two prior figures.

It is noted that, in all figures, same numbers and reference letters, apply to same or equivalent parts or elements constituting the arrangement, in agreement with the example chosen for the present explanation of the invented extracting machine.

### DETAILED DESCRIPTION OF A PREFERRED EMBODIMENT

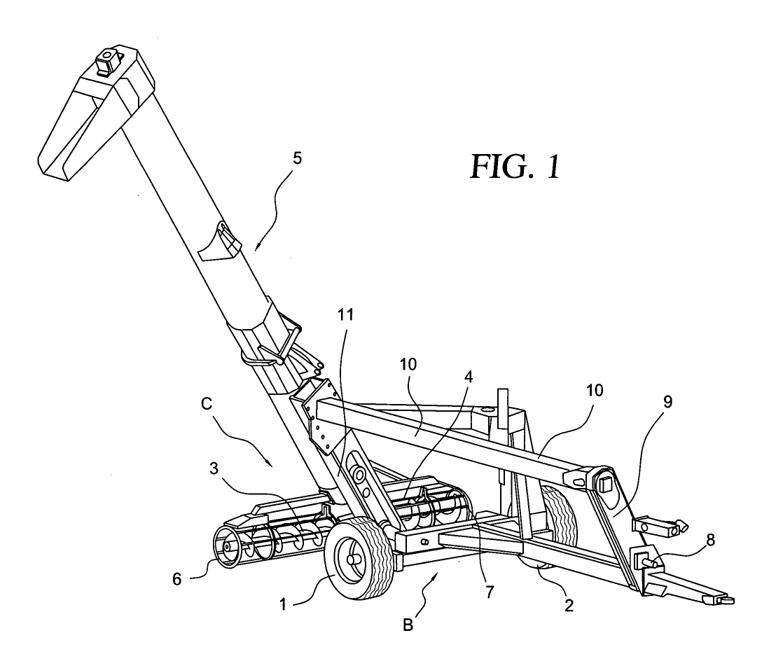

As shown in FIG. 1, the extracting machine of dry grains stored in silage bags referred to in the present patent of invention, is formed by a chassis (B) mounted on wheels (1) and (2), belonging to the type which use a transversal rotating roll, not shown, which function is to roll up the silage bag as the grains it stores are extracted.

Therefore, a feeding and discharge head (C) is used conceived to be placed inside the bag such that as it is being rolled up grains are extracted. Therefore, this head includes both endless transversal rollers (3) and (4) which work in the interior of the bag, adjacent to the bottom, in a simultaneous and coordinated way with a vertical lifting roller (5) which begins in said head and is projected outwardly.

In fact, observing FIG. 1 it is appreciated that said vertical lifting roller (5) is a big tubular body which is centrally projected from the lower adjacent end to the bottom of the bag, keeping certain inclination to a lateral side of the machine.

Likewise, as specially shown by FIGS. 3 and 5, the above mentioned endless transversal rollers (3) and (4) will be locked by a respective lattice cover (6) and (7) formed from the ring supports applicable to the corresponding long rods, conceived to slid on the internal surface of the bag, thus avoiding damages and therefore unwanted grain leakage.

As stated above, the extracting machine of the present invention, is especially distinguished by the particular design and assembly achieved in the mechanic command transmission from its coupling to the exit from the tractor.

In fact, if we observe FIG. 1, we see the entrance axis (8) which is to be coupled to the cardan transmission which extends from the tractor, which is associated to an upward chain (9) mounted on the back beam, smaller in height and with the same slope as the body of the lift (5).

Said upward chain (9) is coupled, at the top, with an end of the horizontal main axis of transmission (10) which extends, keeping an elevated height, to the above mentioned body of the lift (5) to be associated, on the other end, to the downwards chain (11) which allows for the movement to the transmission box (12) place at the bottom of the machine, adjacent to the bottom of the bag.

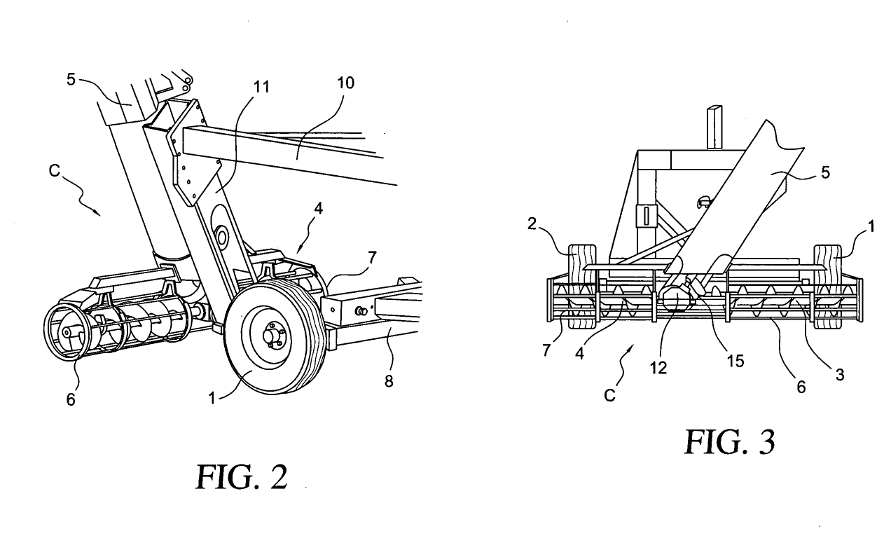

As shown in FIGS. 1 and 2, this downward chain (11) is mounted on the external face of said body of the lift (5) this way assuring the same slope is kept.

The described transmission from the inlet (8) to the lower transmission box (12) is distinguished because it is easily accessibly mounted, this way it is simple to be installed and maintained.

Now observing FIGS. 3, 4 and 5 it is possible to understand the location and disposition of the above mentioned lower transmission box (12) from the exit of the corresponding commands (13), (14) and (15) transmitting the movement to the transversal rollers (3), (4) and vertical lift (5), through which two advantage aspects are assured for the functioning of the extractor, i.e.:
First, the placement adjacent to the bottom of the bag, on which the above transversal rollers (3) and (4) are placed, thus assuring that the sweep is total and effective, whatever the volume of the grains in the interior is.
Second, it is noted that both rollers (3) and (4), and the lift (5) are placed on the same vertical plane, thus assuring a higher functional efficacy since the mass of grains conveyed by the rollers is always oriented to the central sector where the lifting roller is efficiently working.

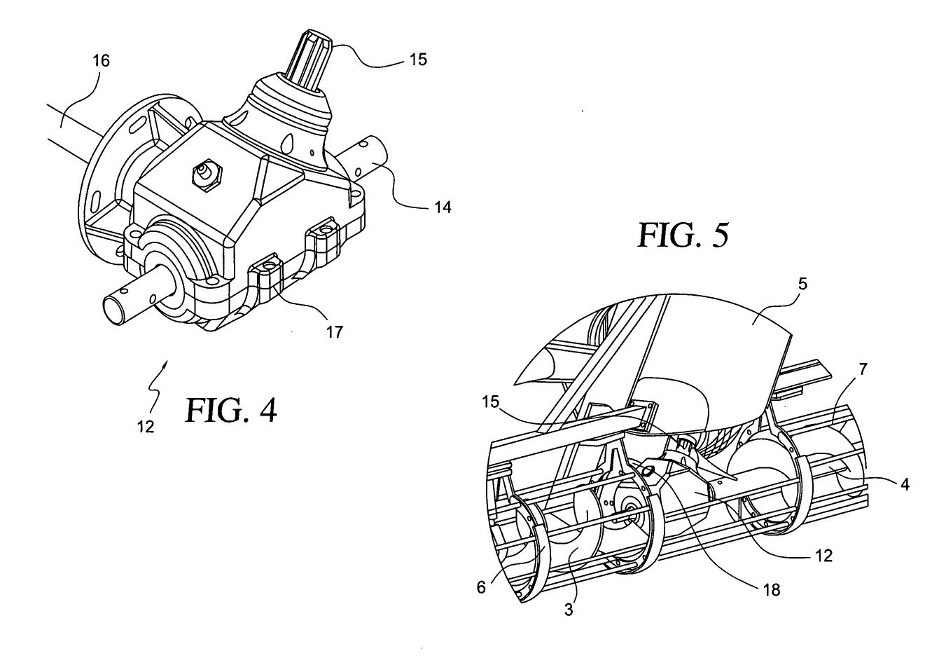

Now observing the transmission box which is represented in FIG. 4, it is possible to appreciate said second advantageous condition, as mentioned above, since that shows at the exits (13), (14) and (15) which are co-planar among them as regards the same vertical plan.

In said FIG. 4 it is also shown the entry axis (16) transmitting the movement which is projected from the coupling with the lower end of the above mentioned downward chain (11), as well as the sliding skates (17) for support on the bottom of the bag.

Likewise, FIG. 5 shows that said transmission box (12) is fixed to the lower sketch of the body of the vertical lift (5) by means of a mounting bridle (18).

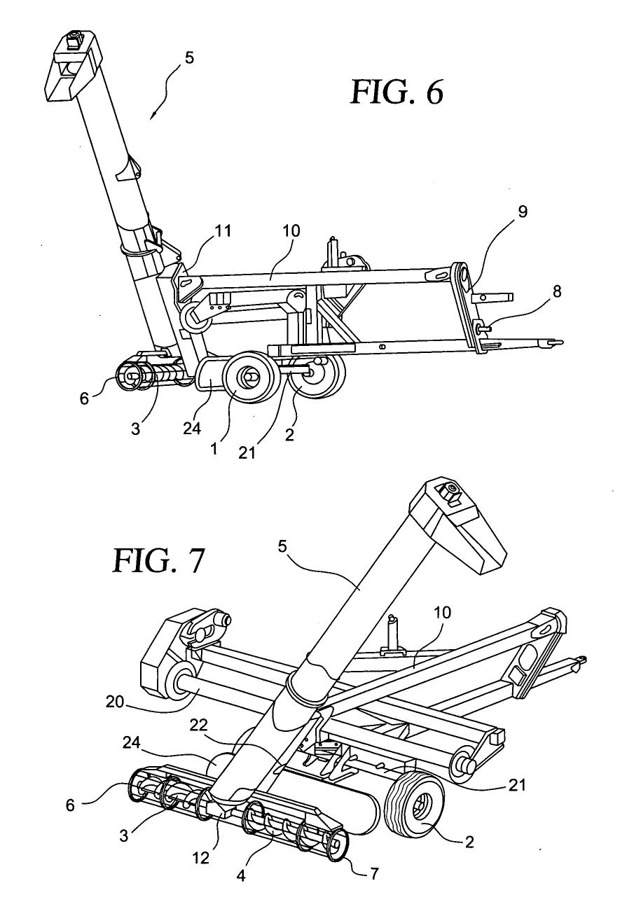

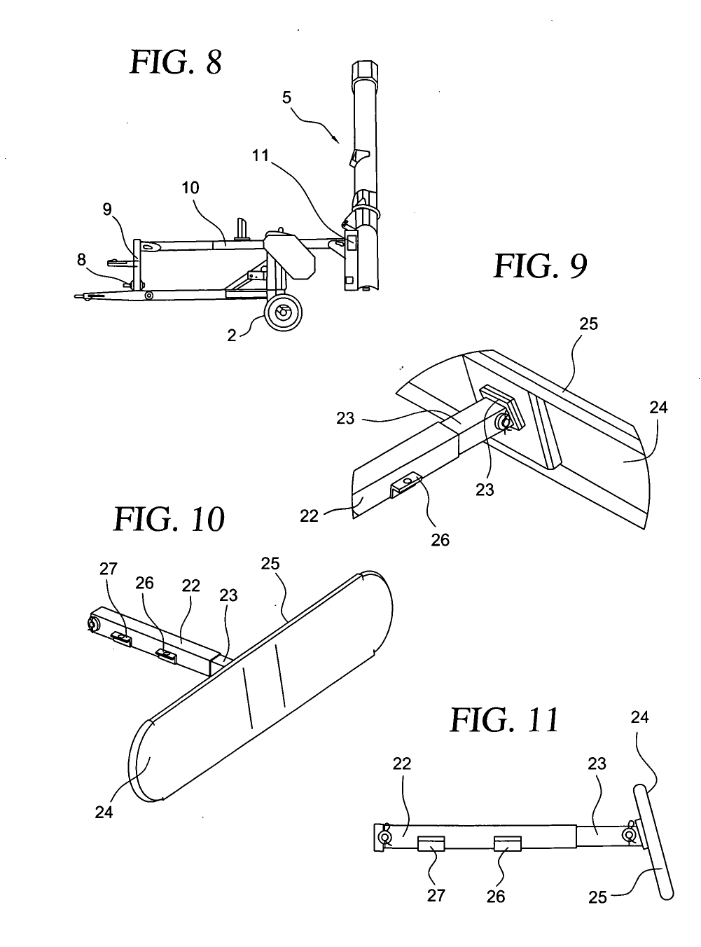

In FIGS. 6,7 and 8, it is also appreciated that from the inferior beam (21) which is part of the chassis of the machine, a long-shaped support (22) is centrally projected, which, at its free end, project a sliding frame (23) which bears the transversal plate (24) which constitutes the pusher shovel of this invention.

As specially shown in the widened detail of FIG. 9, in a preferred embodiment the shovel of this invention includes a tubular frame (25) which supports a flat and totally smooth plate as it should not damage the body of the bag on which it rests and pushes.

Said planar plate (24) may be made of steel or a plastic material which is smooth and resistant without grooves or roughness.

On the same tubular support (22) the free end of the sliding piston rod (23) is fixed, which, in a preferred embodiment, is placed telescopically, in the inner part of said elongated support (22), associated to the plumber of a hydraulic cylinder (not shown) which is oriented to the same longitudinal direction of the machine.

This hydraulic cylinder may be operated by the worker performing the work who, through said resource, may regulate the pushing pressure to be performed by the shovel on the body of the bag as a function of the need of each moment, so that, in the interior of the bag the mass of grains to show up, may be taken efficiently by the transversal sweeping endless rollers (3) and (4).

As shown in FIGS. 9, 10 and 11, in a preferred embodiment, the pusher hydraulic cylinder may be placed inside the above mentioned hollow and long-shaped support (22), which is fixed to the chassis through the flaps (26) and (27).

As noted above, the plumber of said hydraulic cylinder associated with the sliding piston rod (23) is in charge of transmitting and operating its longitudinal displacements.

The invention contemplates a planar plate (24) which constitutes the shovel of this invention to be disposed in a fixed manner to the free end of the piston rod (23), or either articulated, so that a higher possibility to be adapted to deformations to be adopted by the body of the silage bag when it is rolled up on the rolling rod (20) can be achieved.

1. A mechanic extractor of dry grains stored in silage bag with discharge accelerator, of the type having a transversal roll which rolls the bag up as grains stored therein are extracted, to be discharged in a hopper truck or equivalent, which advances adjacent to the extracting machine, for which an extracting head is used which is placed in the interior of the bag, which having a lifting roller centrally arranged which corresponds to the bottom thereof, combined with a pair of transversal rollers (3) and (4) extending to both sides acting as roller resources that, during the advance, orient the grains to the central line to be taken by said lifting roller (5) which elevates and discharges them, characterized in that the command given by the tractor, is transmitted to an entrance axis (8) disposed below at the back sector of the machine, which is disposed associated to an upward transmission chain (9), which takes the movement to an horizontal main axis of transmission (10) which extends, elevated, to the external face of the body of the lifting roller, where it is associated with a downward transmission chain (11) which extends to a transmission box (12) which is centrally placed, at the lower end, supported on the bottom of the bag, in correspondence to the front face of the machine, which has their exit axis (13), (14) and (15), oriented to different directional senses, all of them defined at a single vertical plane, which are coupled, respectively with the axis of the transversal endless rollers (3) and (4) and the lifting roller (5).

2. A mechanic extractor of dry grains stored in silage bag with discharge accelerator, as claimed in claim 1, characterized in that the upward transmission chain is mounted on a vertical beam which extends between the lower objective y and the elevated frame which supports the horizontal principal axis (10), with a lateral slope equivalent to the elevator (5).

3. A mechanic extractor of dry grains stored in silage bag with discharge accelerator as claimed in claim 1, characterized in that the main horizontal axis (10) is mounted in the interior of a long-shaped structural frame disposed elevated, integrating the frame of the machine.

4. A mechanic extractor of dry grains stored in silage bag with discharge accelerator as claimed in claim 1, characterized in that the downward transmission chain is mounted on a long-shaped box fixed on the wall of the vertical lift (5) and extends to be associated to a command transmission horizontal axis which is coupled to the transmission box (12) centrally placed at the lower end, on the floor of the bag.

5. A mechanic extractor of dry grains stored in silage bag with discharge accelerator as claimed in claim 1, characterized in that the transversal endless rollers (3) and (4) dispose their spirals adjacent to the floor.

6. A mechanic extractor of dry grains stored in silage bag with discharge accelerator as claimed in claim 1, characterized in that the transversal endless rollers (3) and (4) are closed into a lattice coat (6) and (7) formed by ring supports corresponding to long-shaped rods.

7. A mechanic extractor of dry grains stored in silage bag with discharge accelerator, as claimed in claim 1, characterized in that the lower transmission box has sliding skates supported at the bottom of the bag.

8. A mechanic extractor of dry grains stored in silage bag with discharge accelerator as claimed in claim 1, characterized in that out of the extractor head and as an inferior and outer resting support of the silage bag which is being rolled up, a pusher planar shovel is placed which is transversally placed covering the width of the silage bag, constituting an external parameter of contention and pushing towards said transversal endless rollers, thus increasing the feeding volume, and accelerating the action of extraction of grains.

9. A mechanic extractor of dry grains stored in silage bag with discharge accelerator as claimed in claim 8, characterized in that, it includes a transversal plate mounted on a sliding frame associated to the plumber of a hydraulic cylinder which is operated from the operation cabinet of the machine; being this piston rod mounted on a hollow and long-shaped support fixed to a lower sketch of the chassis of the machine.

10. A mechanic extractor of dry grains stored in silage bag with discharge accelerator as claimed in claim 9, characterized in that the sliding piston rod is telescopically projected from the interior of the long-shaped support fixed to the chassis.

11. A mechanic extractor of dry grains stored in silage bag with discharge accelerator as claimed in claim 8, characterized in that the pusher planar shovel which is transversally placed covering the width of the silage bag, is fixedly mounted on the free end of the sliding piston rod.

12. A mechanic extractor of dry grains stored in silage bag with discharge accelerator as claimed in claim 8, characterized in that the pusher planar shovel which is transversally placed covering the width of the silage bag, is articulated on the free end of the sliding piston rod.
